(19) United States
(12) Patent Application Publication
(10) Pub. No.: US 2015/0370991 A1
(43) Pub. Date: Dec. 24, 2015

(54) SYSTEMS AND METHODS FOR OPERATING A CHRONIC DISEASE MANAGEMENT PLATFORM

(71) Applicant: KANNACT, Portland, OR (US)

(72) Inventors: Raghava BHARADWAJ, Cupertino, CA (US); Michael A. May, Corvallis, OR (US)

(21) Appl. No.: 14/743,964

(22) Filed: Jun. 18, 2015

Related U.S. Application Data
(60) Provisional application No. 62/013,952, filed on Jun. 18, 2014.

(51) Int. Cl. G06F 19/00

(52) U.S. Cl. CPC G06F 19/3437; G06F 19/3481

(57) ABSTRACT

Systems and methods for chronic disease management are disclosed. In some embodiments, a method includes, at a server having one or more processors and memory storing one or more programs for execution by the one or more processors, obtaining one or more user-specific socio-cognitive vectors corresponding to a first user. The method further includes creating a user-specific engagement model in accordance with the one or more obtained socio-cognitive vectors, and generating a user-specific chronic disease management plan for the first user, in accordance with the user-specific engagement model.

### CROSS REFERENCE TO RELATED APPLICATION

This application claims priority to U.S. Provisional Patent Application No. 62/013,952, entitled “Systems and Methods For Operating A Chronic Disease Management Platform,” filed Jun. 18, 2014, which is hereby incorporated by reference herein in its entirety.

### TECHNICAL FIELD

The present invention relates generally to the chronic disease management industry. More particularly, the invention is directed to generating a chronic disease management plan.

### BACKGROUND

As of this application, a mere 5% of the U.S. population makes up nearly 50% of the nation's healthcare spending. Most of this population has one or more chronic health conditions. This excessive spending on healthcare comes from costs such as hospital visits, medication, emergency room visits, home health care and hospice stays. A significant cause for waste of healthcare dollars among this population is a lack of patient follow up and ensuring patients adhere to their care plans.

Chronic disease management and treatment poses different challenges than management of non-chronic diseases and disorders. Chronic disease management requires dedication and discipline on the part of the patient and patience and individual assessment on the part of the health care provider.

Unfortunately, as health care resources for chronic disease management become stretched thin, patients lose individualized assessments from caregivers and consequently the motivation to keep up with their chronic management plans.

### BRIEF DESCRIPTION OF THE DRAWINGS

For a better understanding of the nature and objects of the invention, reference should be made to the following detailed description, taken in conjunction with the accompanying drawings, in which:

FIG. 1 is a block diagram of an electronic network for providing a chronic disease management plan, according to some embodiments;

FIG. 2A is a block diagram of the client device memory shown in FIG. 1, according to some embodiments;

FIG. 2B is a block diagram of the care provider device memory shown in FIG. 1, according to some embodiments;

FIG. 3A illustrates exemplary vectors and an engagement model for a first patient, according to some embodiments;

FIG. 3B illustrates exemplary vectors and an engagement model for a second patient, according to some embodiments;

FIG. 3C is a block diagram of the backend structure of a chronic disease management plan, according to some embodiments;

FIGS. 4A-4M illustrate exemplary user interfaces for a chronic disease management program, according to some embodiments; and

FIGS. 5A-5B are flow charts of a method for chronic disease management, according to some embodiments.

Like reference numerals refer to corresponding parts throughout the several views of the drawings.

### SUMMARY

Chronic care management plans should encompass a multi disciplinary approach to nutrition, medication and biometric measurement adherence. This can best be achieved by a care team that can be on standby 24×7 to take appropriate action and avoid unnecessary emergency medical intervention. In order to establish such a program that can engage patients in their own healthcare, patient chronic disease management plans have to be tailored to their individual abilities taking into account their self efficacy, social context and knowledge. In addition, appropriate technology that enables remote management of patients, instant communication, education conveyance and an easy user interface for patients and care providers is necessary to make the program effective. The disclosure laid out in this application is a way for creating an effective and personalized digital model of engagement with patients taking their unique styles and abilities into consideration.

The present invention provides a computer implemented method for chronic disease management, performed at a server having one or more processors and memory storing one or more programs for execution by the one or more processors. The method includes obtaining one or more user-specific socio-cognitive vectors corresponding to a first user, creating a user-specific engagement model in accordance with the one or more obtained socio-cognitive vectors, and generating a user-specific chronic disease management plan for the first user, in accordance with the user-specific engagement model.

In some embodiments, the method includes obtaining feedback from the first user regarding the user-specific socio-cognitive vectors and revising the chronic disease management plan, in accordance with the user-specific socio-cognitive vectors in the obtained feedback. In some embodiments, the method further includes obtaining feedback from an entity other than the first user regarding the user-specific socio-cognitive vectors and revising the chronic disease management plan, in accordance with the user-specific socio-cognitive vectors in the obtained feedback.

In some embodiments, the method further includes monitoring performance of the first user's engagement with the chronic disease management plan and revising the chronic disease management plan, in accordance with the monitored performance of the first user's engagement. In some embodiments, monitoring performance of the first user's engagement with the chronic disease management plan comprises obtaining one or more biometric readings for the first user over a predetermined period of time. In some embodiments, the one or more socio-cognitive vectors include at least one of the following: learning style, self-motivation, current knowledge of the chronic disease, current knowledge of treatment of the chronic disease, self-efficacy, communication style, psychological state, age, economic state, language, support system, motivational anchors, social context comfort with technology, organization skills and education level. In some embodiments, obtaining one or more user-specific socio-cognitive vectors corresponding to a first user is performed by one or more of the following techniques: electronic communication, in-person communication, telephonic communication, online questionnaire and communication through an authorized representative.

In another aspect, a computing system includes memory, one or more processors, and one or more programs stored in the memory and configured for execution by the one or more processors to perform any one of the methods described above.

In yet another aspect, a non-transitory computer readable storage medium stores one or more programs for execution by one or more processors of a computing system, the one or more programs including instructions for performing any one of the methods described above.

### DETAILED DESCRIPTION

The implementations described herein provide various technical solutions to improve the health of patients, and in particular to the above-identified problems, by providing techniques for chronic disease management. Details of implementations are now described in relation to the Figures.

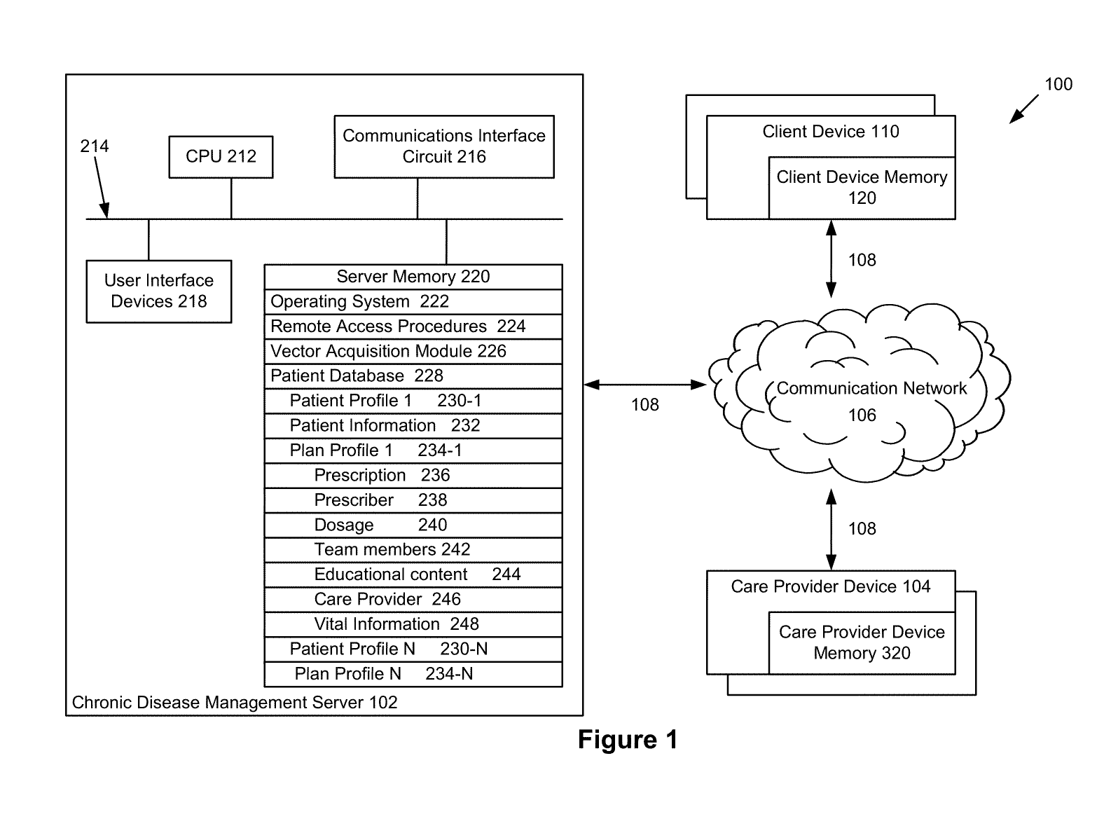

FIG. 1 is a diagrammatic view of an electronic network 100 for chronic disease management in accordance with some embodiments. The network 100 comprises a series of points or nodes interconnected by communication paths. The network 100 may interconnect with other networks, may contain subnetworks, and may be embodied by way of a local area network (LAN), a metropolitan area network (MAN), a wide area network (WAN), or a global network (the Internet). In addition, network 100 may be characterized by the type of protocols used on it, such as WAP (Wireless Application Protocol), TCP/IP (Transmission Control Protocol/Internet Protocol), NetBEUI (NetBIOS Extended User Interface), or IPX/SPX (Internetwork Packet Exchange/Sequenced Packet Exchange). Additionally, the network 100 may be characterized by whether it carries voice, data, or both kinds of signals; by who can use the network 100 (whether it is public or private); and by the usual nature of its connections (e.g. dial-up, dedicated, switched, non-switched, or virtual connections).

The network 100 connects a plurality of client devices 110 and care provider devices 104 to at least one chronic disease management server 102. This connection is made via a communication or electronic network 106 that may comprise an Intranet, wireless network, cellular data network or preferably the Internet. The connection is made via communication links 108, which may, for example, be coaxial cable, copper wire (including PSTN, ISDN, and DSL), optical fiber, wireless, microwave, or satellite links. Communication between the devices and servers preferably occurs via Internet protocol (IP) or an optionally secure synchronization protocol, but may alternatively occur via electronic mail (email).

In some embodiments, a client device corresponds to a device used by a patient or support person for the patient of a chronic disease (e.g., a patient with diabetes, or that patient's parents). In some embodiments, a care provider device corresponds to a person having the authority to authorize treatment of the patient's chronic disease. Depending on the laws of any particular jurisdiction, such a person includes, without limitation, physicians, physician assistants, registered nurses, or persons acting under the direction of these individuals.

The chronic disease management server 102 is shown in FIG. 1, and is described below as being distinct from the care provider devices 104, and client devices 110. The skilled artisan will, however, appreciate that in some embodiments, the chronic disease management server 102 and the care provider devices 104 are one and the same without deviating from the scope of the present invention.

The chronic disease management server 102 comprises at least one data processor or central processing unit (CPU) 212, a server memory 220, (optional) user interface devices 218, a communications interface circuit 216, and at least one bus 214 that interconnects these elements. The server memory 220 includes an operating system 222 that stores instructions for communicating, processing data, accessing data, storing data, searching data, etc. The server memory 220 also includes remote access procedures 224 and a vector acquisition module 226. In some embodiments, the remote access procedures 224 are used for communicating (transmitting and receiving) data between the chronic disease management server 102 and the electronic network 106. In some embodiments, the vector acquisition module 226 is used for obtaining one or more socio-cognitive vectors for one or more patients. In some embodiments, the vector acquisition module 226 stores vector scores for one or more patients, survey questions or other procedures to obtain vector scores from one or more patients, and raw data obtained for one or more patients to determine vector scores (e.g., answers to survey questions, feedback from care providers etc.).

The server memory 220 further includes a patient database 228 preferably containing a plurality of patient profiles 230-1 to 230-N. In some embodiments, each patient profile 230-1 to 230-N contains patient information 232, such as contact details, information concerning the patient's medical history, the patient's medical insurance details, etc. In some embodiments, each patient profile 230-1 to 230-N contains one or more chronic disease management plan profiles 234 for that particular patient. In some embodiments, each plan profile 234 also contains information such as prescription information 236 for one or more prescribed pharmaceuticals, a prescriber identifier 238 (e.g., the patient's doctor), the dosage(s) 240 of the one or more prescribed pharmaceuticals, and other prescription-related information such as refill details, and a dispenser identifier. Some chronic disease management plans do not require prescription-related information. In some embodiments, a respective plan profile 234 contains plan information such as team members 242 (e.g., names and contact information of people supporting the patient) and educational content 244 (e.g., educational material pertaining to the patient's disease). In some embodiments, the patient database 228 also comprises information regarding individual chronic disease management plans such as the frequency of contact, the type of contact to make with the patient, the primary care provider 246 (e.g., the person using care provider device 104), the vital information 248 (e.g., blood pressure values over time), prior communications between the client device 110 and care provider device 104 and adjustments made to prior chronic disease management plans for a particular patient, to create the current plan (e.g., increased the frequency of reminders).

The client devices 110 and care provider devices 104 access the communication network 106 via remote client computing devices, such as desktop computers, laptop computers, notebook computers, handheld computers, smart phones, or the like. The client devices 110 and care provider devices 104 each include a data processor or central processing unit (CPU), user interface devices, communications interface circuits, and buses, similar to those described in relation to the renewal server 102. The client devices 110 and the care provider devices 104 also include memories 120 and 320 respectively, described below. Memories 220, 120, and 320 may include both volatile memory, such as random access memory (RAM), and non-volatile memory, such as a hard-disk or flash memory.

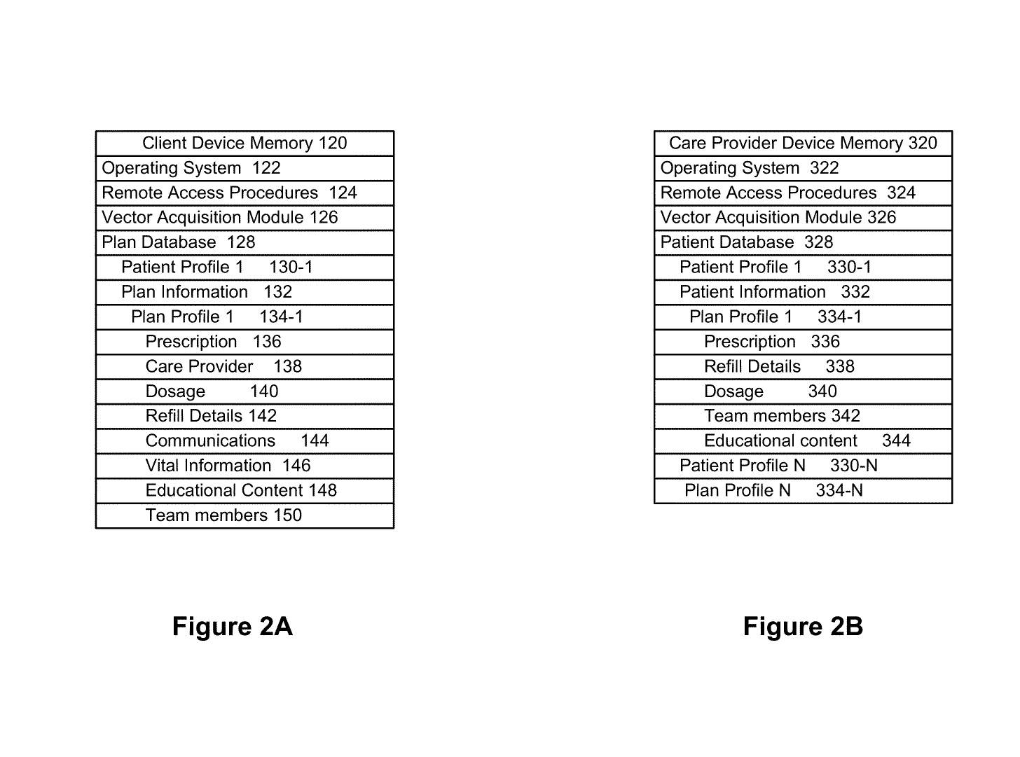

FIG. 2A is a block diagram of the client device memory 120 shown in FIG. 1, according to some embodiments. The client device memory 120 includes an operating system 122 and remote access procedures 124 compatible with the remote access procedures 224 (FIG. 1) in the server memory 220 (FIG. 1). In some embodiments, the client device memory 120 also includes a vector acquisition module 126 for obtaining information to determine socio-cognitive vector scores. In some embodiments, vector acquisition module 126 residing in client device memory 120, obtains information to generate scores based on the answers to survey questions. In some embodiments, these questions are preloaded in client device memory 120, and in some embodiments, these questions are obtained and downloaded from the vector acquisition module 226 in server memory 220 over communication network 106 (see FIG. 1).

In some embodiments, client device memory 120 also comprises a chronic disease management plan database 128. Plan database 128 typically only includes information for one plan for one patient, but in some embodiments, plan database 128 comprises more than one plan for one or more patients. In some embodiments, plan database 128 comprises one or more patient profiles (e.g., patient profile 130-1). In some embodiments, a patient profile includes information about the patient using client device 110, such as name, age, weight, chronic disease, other medical conditions, family medical history, insurance information and emergency contact information.

In some embodiments, plan database comprises general plan information 132, such as the length of time the patient has been using the chronic disease management plan, how many times the plan was modified, how the plan was modified, and any significant events during the course of the plan (e.g., long lapses in activity).

In some embodiments, the plan information 132 also comprises more patient-specific information under a plan profile (e.g., plan profile 134-1). In some embodiments, a plan profile 134 comprises prescription information 136, and dosage information 140 and refill details 142 regarding a specific prescription. In some embodiments, plan profile 134 comprises the patient's primary care provider's information 138, in some cases also the prescribing doctor for one or more prescriptions stored in plan profile 134. In some embodiments, the plan profile 134 comprises communications 144 (e.g., communications between the patient and a care provider or support person), vital information 146 (e.g., biometric readings), educational content 148 (e.g., stored pdf files on the patient's disease) and team member information 150 (e.g., names and contact information for the patient's support group).

FIG. 2B is a block diagram of the care provider device memory 320 shown in FIG. 1, according to some embodiments. The care provider device memory 320 includes an operating system 322 and remote access procedures 324 compatible with the remote access procedures 224 (FIG. 1) in the server memory 220 (FIG. 1). The care provider device memory 320 preferably also includes a vector acquisition module 326 for obtaining, managing and interpreting vector scores for one or more patients.

In some embodiments, the care provider device memory 320 comprises a patient database 328 comprising one or more patient profiles 330 (e.g., patient profile 330-1 to patient profile 330-N). In some embodiments, a respective patient profile 330 comprises patient information 332 (e.g., name, contact information, chronic disease, age, weight, gender etc. for a respective patient of the care provider). In some embodiments, a patient profile 330 comprises information regarding the specific patient's plan, such as prescription info 336, refill details 338, dosage 340, team members 342 (e.g., the patient's support network) and educational content 344 sent to the patient. This is not intended to be an exhaustive list of qualities that can be stored in patient database 328. For example, additional information stored in patient database 328 includes the patient's engagement model, information about previous chronic disease management plans, a complete medical history for the patient, feedback from other care providers (e.g., registered nurses, psychiatrists, or social workers) and the patient's vital information (e.g., measurements of blood glucose over time).

It should be noted that the various databases described above have their data organized in a manner so that their contents can easily be accessed, managed, and updated. The databases may, for example, comprise flat-file databases (a database that takes the form of a table, where only one table can be used for each database), relational databases (a tabular database in which data is defined so that it can be reorganized and accessed in a number of different ways), or object-oriented databases (a database that is congruent, with the data defined in object classes and subclasses). The databases may be hosted on a single server or distributed over multiple servers.

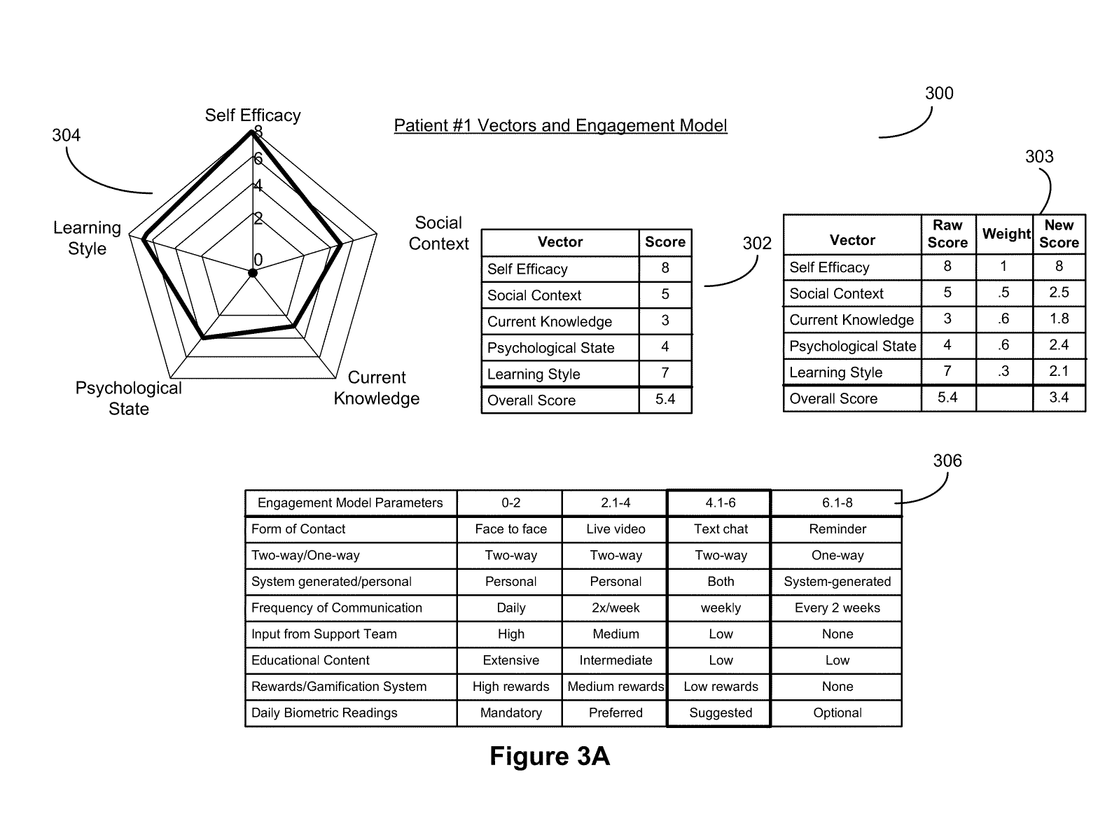

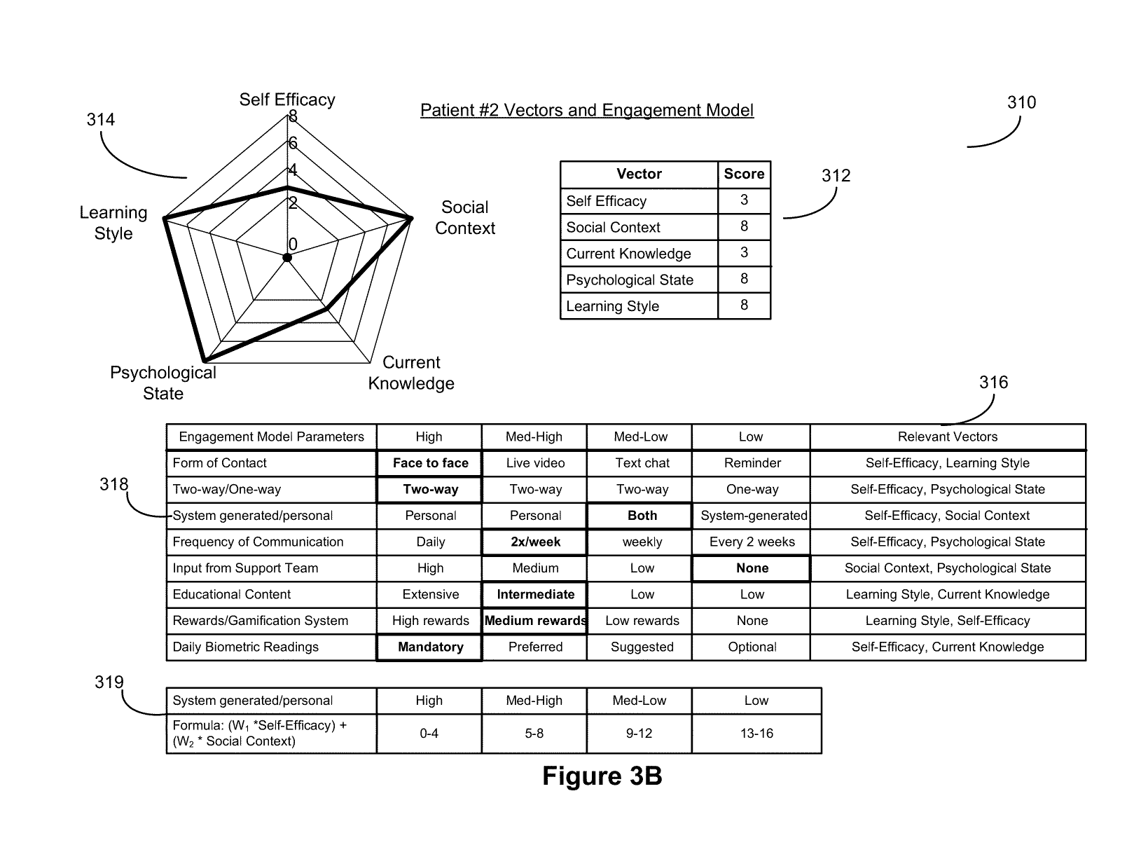

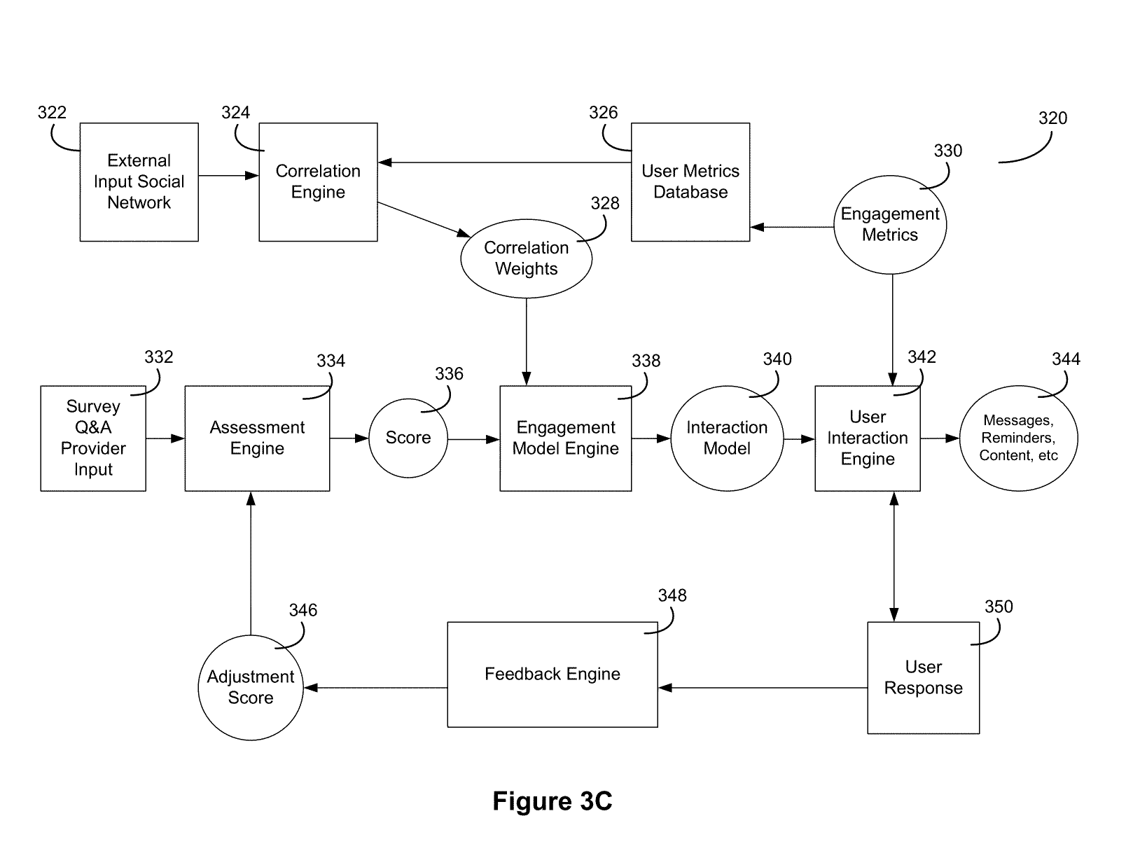

FIG. 3A illustrates exemplary vectors and an engagement model for a first patient with a chronic disease (e.g., diabetes), according to some embodiments. In some embodiments, FIG. 3A illustrates an exemplary patient assessment 300. In patient assessment 300, a vector table 302 lists some examples of socio-cognitive vectors (e.g., self efficacy, social context, current knowledge, psychological state and learning style). The exemplary vectors shown in vector table 302 are not an exhaustive list of potential vectors used in patent assessment 300. In some embodiments, fewer than five socio-cognitive vectors are assessed for a respective patient, and in some embodiments, greater than five socio-cognitive vectors are assessed for a respective patient.

In some embodiments, the socio-cognitive vectors for a respective patient (e.g., patient #1), are used to assess how the respective patient absorbs information and follows medical recommendations. In some embodiments, the socio-cognitive vectors are assessed on a numerical scale (e.g., 0 to 8 or 0 to 10), and in some embodiments, the socio-cognitive vectors are assessed on a quantitative scale (e.g., low, medium, high). FIG. 3A also illustrates a graphical representation 304 of the socio-cognitive vectors of vector table 302. In some embodiments, graphical representation 304 provides a quick way for a care provider to understand the particular learning style and psychological state of the respective patient (e.g., patient #1).

In assessment 300, patient #1 is shown to have a very high score in self efficacy. In some embodiments, a high score in self efficacy indicates a strong belief in one's own ability to complete tasks and reach goals. In some embodiments, a high score in self efficacy indicates that the respective patient is able to absorb more information, and is apt to initiate and sustain substantive change in health related behaviors. In some embodiments, a high score in self efficacy is used by the disclosed methods to develop or adjust an engagement model for a respective patient. For example, in assessment 300, patient #1's high score of self efficacy indicates that he needs less encouragement and less frequent positive reinforcement to continue with a prescribed treatment plan. In some embodiments, as for the vector “Self Efficacy,” a score represents a degree of that vector (e.g., on a scale of 0-8, a score of 8 indicates a high degree of self efficacy).

In assessment 300, patient #1 has a score of 5 for social context. In some embodiments, a social context score reflects the life circumstances of the patient, such as his support systems, involvement of caregivers, access to health care and/or financial situation. In some embodiments, a score for a respective vector (e.g., social context) indicates a degree of that vector, based on more than one criterion. For example, a relatively low score in the social context category can be assigned to a patient with strong involvement from caregivers, but poor access to healthcare and an unstable financial situation. Similarly, a low score in the social context category can be assigned to a patient with weak support systems, low involvement from caregivers, easy access to health care and an average financial situation.

In assessment 300, patient #1 has a score of 3 for current knowledge. In some embodiments, a patient's current knowledge of their chronic disease is the greatest predictor of his ability to acquire new actionable knowledge. In some embodiments, the patient's score for current knowledge assesses the quality of the knowledge that the patient has acquired. For example, a respective patient that believes to possess a lot of knowledge about his chronic disease but turns out to be misinformed or has an erroneous understanding of it, will be given a low score. In some embodiments, a patient with very little knowledge (erroneous or correct), will receive a higher score for current knowledge than a patient with erroneous knowledge.

In assessment 300, patient #1 has a score of 4 for psychological state. In some embodiments, a respective patient's psychological state is relevant to his chronic disease management plan because patients who are depressed and/or anxious will struggle to follow any regimen of care. In some embodiments, the chronic disease management plan for a respective patient includes treating a patient's anxiety or depression as well. In some embodiments, even mild depression is assessed to impair motivation and learning, therefore the engagement model for the respective patient indicates a need for periodic reassessment. In assessment 300 and in some embodiments, a high score for psychological state indicates a patient has a relatively stable mental state and a low score indicates that the patient is suffering from a degree of anxiety or depression.

In assessment 300, patient #1 has a score of 7 for learning style. In some embodiments, a score for learning style indicates a degree of visual or pictorial learning preferred by the respective patient, or a degree of auditory or verbal learning preferred by the respective patient. In some embodiments, patients exhibit a stronger preference for one style rather than the other, but a mid-range score indicates a patient that prefers both visual and auditory learning relatively equally.

In exemplary assessment 300, vector table 302 also comprises an overall score for patient #1. In some embodiments, an overall score is determined for a patient using a simple average score of all the vector scores (e.g., 5.4 is the average of 8, 5, 3, 4 and 7). In some embodiments, as shown in vector table 303, the overall score is a weighted average of the various socio-cognitive vectors. In some embodiments, the weights for the weighted average depend on the importance of a respective socio-cognitive vector to the engagement model (e.g., self efficacy may have a greater weight than learning style). In some embodiments, the weights are adjusted to be more conservative or less conservative in engagement with the patient. For example, as show in vector table 303, weighted values of 0 to 1 result in an overall score for the patient that will always be lower than an unweighted overall score (e.g., 3.4 is lower than 5.4). As discussed below, in some embodiments, a lower score results in a more aggressive engagement model with the patient (i.e., more interaction with the patient, or more personal engagement).

In some embodiments, scores for a patient are obtained in the context of the patient's age or in light of any of the patient's learning disabilities. For example, different survey questions are used for children than for adults, to determine the socio-cognitive vector scores. In some embodiments, the methodology for obtaining the socio-cognitive vector scores for a patient depends on the chronic disease that he suffers from. In some embodiments, scores are normalized, depending on the age or other factors affecting the outcome of the patient's scores compared to those of an average adult. In some embodiments, the weights for a weighted score vary depending on the patient's age, learning ability, chronic disease, duration of time in the disease management program or other variables.

FIG. 3A also illustrates an exemplary engagement model for patient #1, represented by engagement model table 306. In some embodiments, the engagement model is computer-generated after taking a respective patient's socio-cognitive vector scores for various vectors and assessing that patient's learning and motivational needs. Engagement model table 306 illustrates an exemplary technique of obtaining at least an initial engagement model with patient #1. This exemplary technique uses the overall score (however that is determined from the vectors), to determine the values of various engagement model parameters for patient #1. For example, with an overall score of 5.4, shown in FIG. 3A, patient #1 is assessed to fit into the third category of engagement model table 306. The exemplary chronic disease management plan for patient #1 involves contacting the patient by text chats, using two-way communication between the patient and a care provider, using a mixture of system-generated and personal communications or reminders, sending weekly communications, requiring low input from his support team, sending a low volume of educational content, providing a low volume of rewards and suggesting that the patient acquire and send biometric readings to the care provider on daily basis.

FIG. 3B illustrates exemplary assessment 310, vector scores in vector table 312, graphical depiction of vector scores 314 and an engagement model represented by engagement model table 316 for a second patient, according to some embodiments. In some embodiments, one vector affects more than one element of an engagement model. For example, a patient's low psychological state score determines that he requires more frequent contact, with as much personal attention as possible, from one or more care providers.

In FIG. 3B, there is no overall score determined for patient #2, rather the individual vector scores are used to assess each engagement model parameter at a time. For example, the engagement model table 316 of assessment 310 indicates relevant vectors for a respective parameter of the table. In this example, for the form of contact with the patient, it has been predetermined that the scores for self-efficacy and learning style will have the most relevance to whether to engage the patient with face-to-face contact, live video, text chat or simply text-based reminders.

In some embodiments, values for engagement model parameters are developed using a weighted consideration of one or more of the assessed socio-cognitive vectors for a respective patient. For example, the parameter 318 of system generated or personal communication from a care provider is determined using a formula combining a weighted or unweighted value of self efficacy and social context. In this example, table 319 illustrates a possible formula to determine the category (e.g., high, med-high, med-low or low) to select for the system generated/personal parameter 318. In this example, patient #2 had a score of 3 for self-efficacy and a score of 8 for social context, totaling a score of 11, and placing him in the med-low category for the system generated/personal parameter 318. Here, weights W₁ and W₂ are each unity, whereas in other embodiments W₁ and W2 are scaled based on the relative importance of the self-efficacy and social context socio-cognitive vectors for the given chronic disease under consideration. Moreover, likewise, the other engagement model parameters in the engagement model table 316 are determined by other lookup tables (not shown) that have individualized formulas based on the socio-cognitive vectors scores in vector table 312 (e.g., combinations of certain socio-cognitive vectors scores, weighted combinations of certain socio-cognitive vectors scores, etc.).

In some embodiments, external factors are taken into consideration to determine the engagement model in addition to the socio-cognitive vectors. For example, the availability of care providers or the data connection of the patient or care provider to the internet.

In some embodiments, socio-cognitive vectors are ranked in order of priority for their use in generating an engagement model. In some embodiments, socio-cognitive vectors are ranked in order of priority based on the chronic disease faced by the patient, the patient's age or another characteristic of the patient. For example, the vector ranked of highest priority for a 5 year old patient is the social context vector, while the vector ranked of highest priority for a 30 year old patient is self efficacy.

In some embodiments, an element of the engagement model is determined based on the range of one or more vector scores for the respective patient. For example, a self efficacy score between 2 and 4 (out of a scale from 0 to 8), and a psychological state score between 6 and 8 results in a frequency of communication parameter of the engagement model being set to two times per week.

FIG. 3C is a block diagram of the backend structure 320 of a chronic disease management engagement system, according to some embodiments. FIG. 3C illustrates the various components that come together for an exemplary structure to generate interaction model 340 (e.g., a user-specific engagement model). Generally speaking, interaction model 340 is the output of engagement model engine 338. In some embodiments, engagement model engine 338 produces interaction model 340 after taking one or more scores 336 (e.g., socio-economic vector scores) into account. These scores are described in more detail above, with respect to FIGS. 3A and 3B. The engagement model engine 338 also relies on correlation data arising from user metrics database 326, statistical database 324 and feeding into correlation weights 328.

Correlation engine 324 correlates engagement vectors with patient engagement metrics and generates minor corrections in correlation weights 328. User metrics database 326 includes data collected from the chronic disease management engagement system, such as data about patient engagement behavior and deviations from that expected behavior. Correlation engine 324 includes statistical data such as correlation data between engagement vectors and social network engagement metrics. The statistical data is collected from random samples of members of various social networks.

Assessment engine 334 takes various forms of input, such as survey, Q&A or care provider input 332, to produce one or more scores 336. In some embodiments, assessment engine 334 also takes feedback in the form of an adjustment score 346 based on a deviation from a patient's model engagement to observed engagement. In some embodiments, adjustment score 346 is a positive or negative correction to the correlation weights 328, resulting in an adjustment to the overall score 336. In some embodiments, adjustment score 346 is based on a percentage of deviation of patient engagement from a baseline expected engagement. In some embodiments, observed engagement and expected engagement are each expressed as quantitative measurements of a patient's interaction with the chronic disease management engagement system.

In some embodiments, adjustment score 346 is generated by feedback engine 348. In some embodiments, feedback engine 348 monitors the user's behavior (i.e., user response 350) with respect to actions such as responses to care provider or support team questions, number of views or accesses to the chronic disease management plan, social network presence, application usage, and/or chronic disease management plan adherence. In some embodiments, feedback engine 348 uses this information to change the user's model score (i.e., resulting in adjustment score 346), which gets fed into assessment engine 334 to generate score 336.

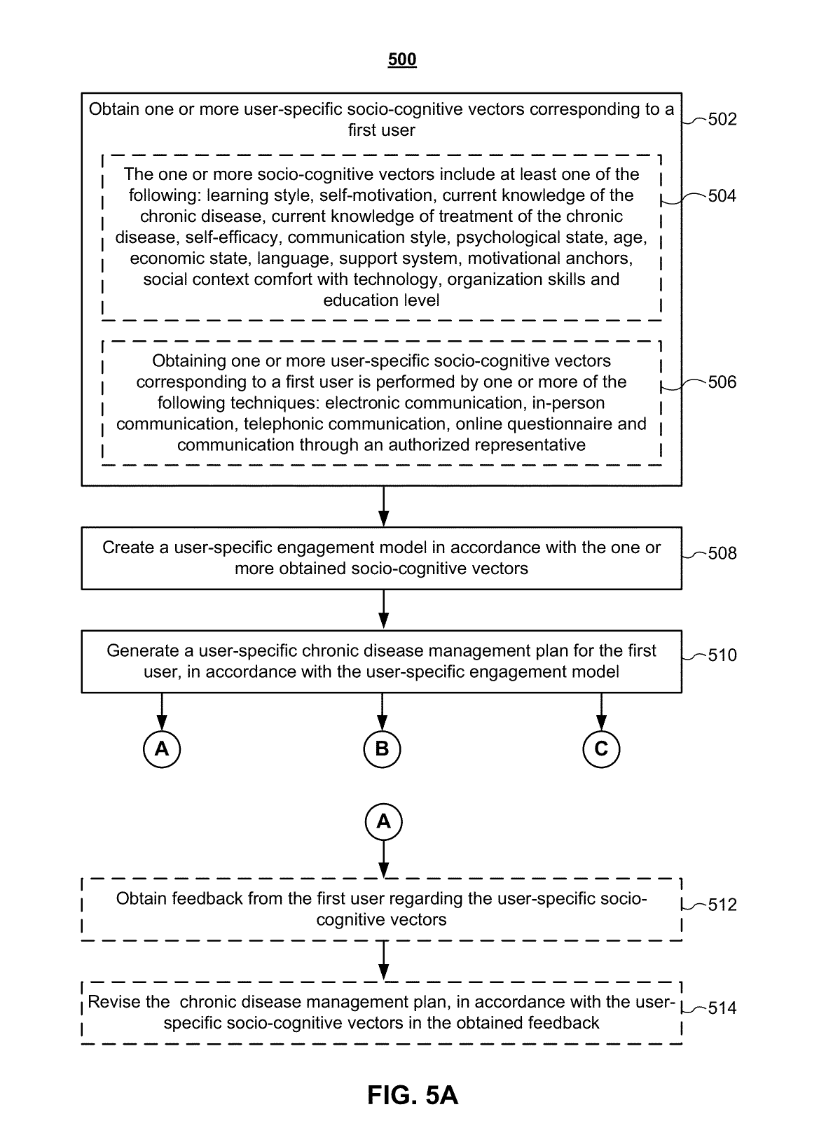

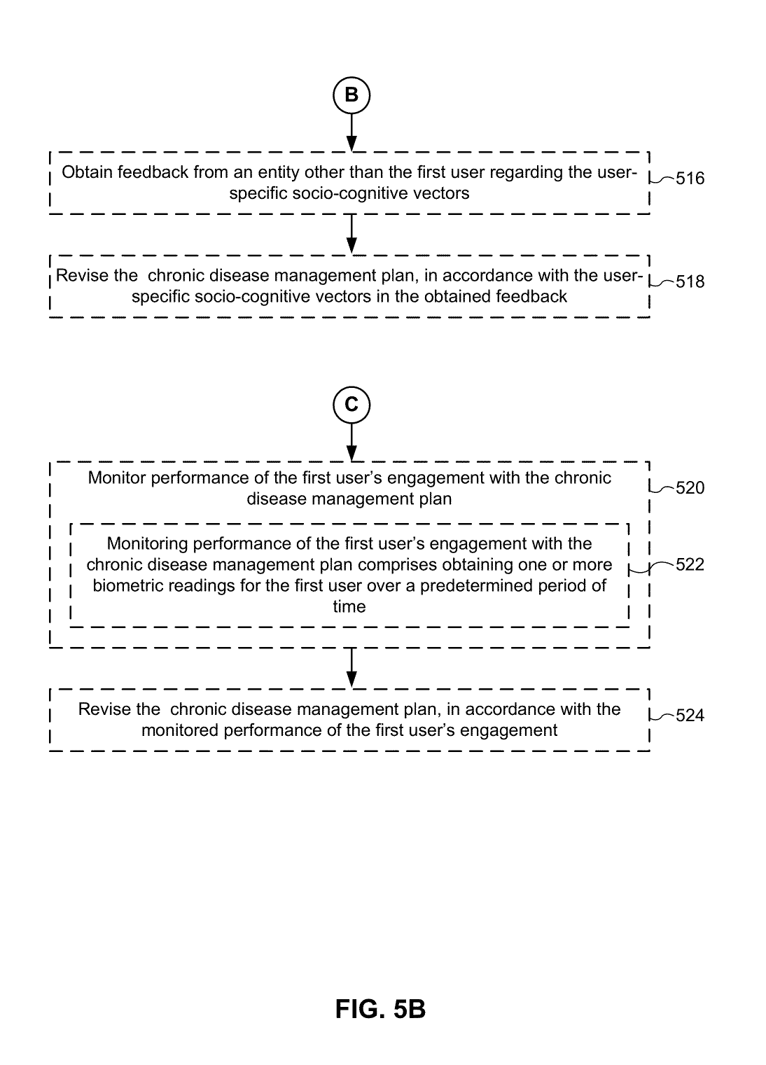

User interaction engine 342 implements the chronic disease management plan by taking interaction model 340, user response 350, and engagement metrics 330 as inputs to determine how to throttle the interactions 344 (e.g., messages, reminders, educational content) to the user. Engagement metrics 330 include the frequency of usage of various aspects of the chronic disease management plan and the patient's adherence to his plan through measures such as his frequency of measuring biometrics, viewing educational content or answering questions and surveys. Engagement metrics 330 are also fed into user metrics database 326, which in some embodiments, stores metrics corresponding to a plurality of users such as user engagement values, biometric readings, health readings and survey answers. In some embodiments, user metrics database 326 is fed into statistical database 324. Another exemplary input to statistical database 324 is external input social network 322. In some embodiments, user engagement data is obtained from external social networks 322, and correlated with socio-cognitive vector assessment scores collected through surveys of users of these social networks. In some embodiments, the backend structure 320 is used to implement any of the methods described with respect to FIGS. 5A-5B.

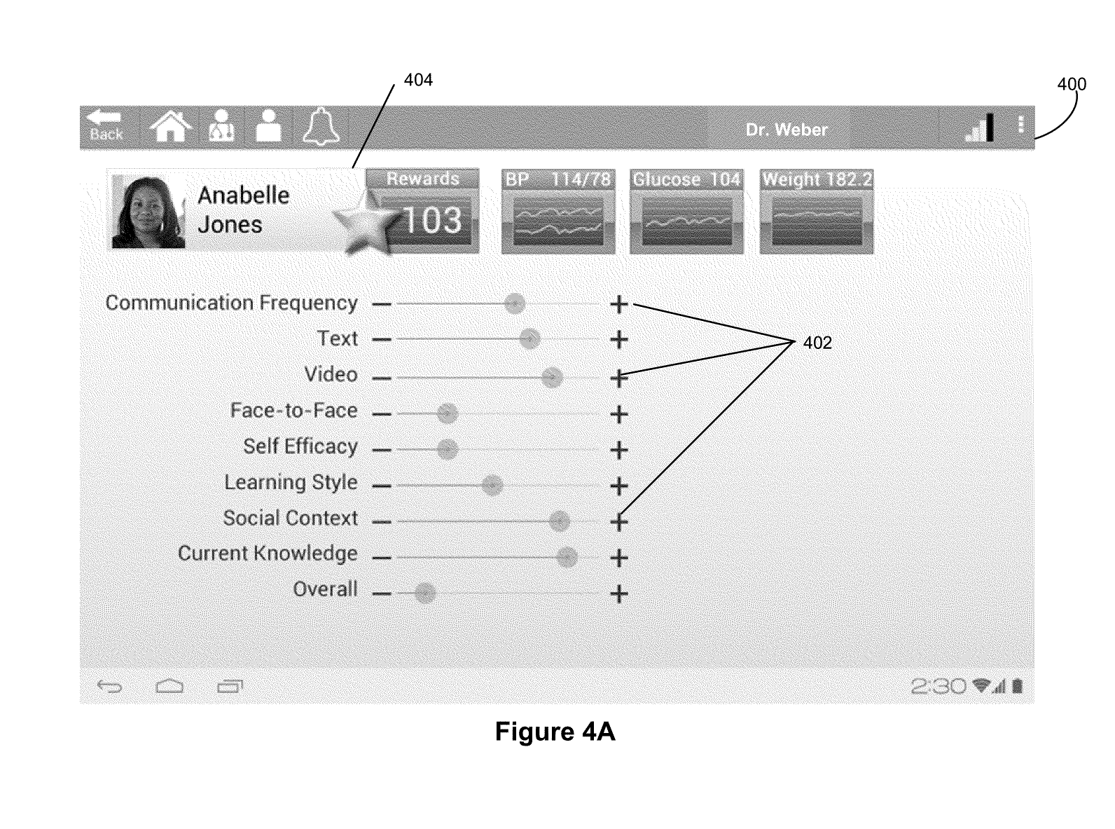

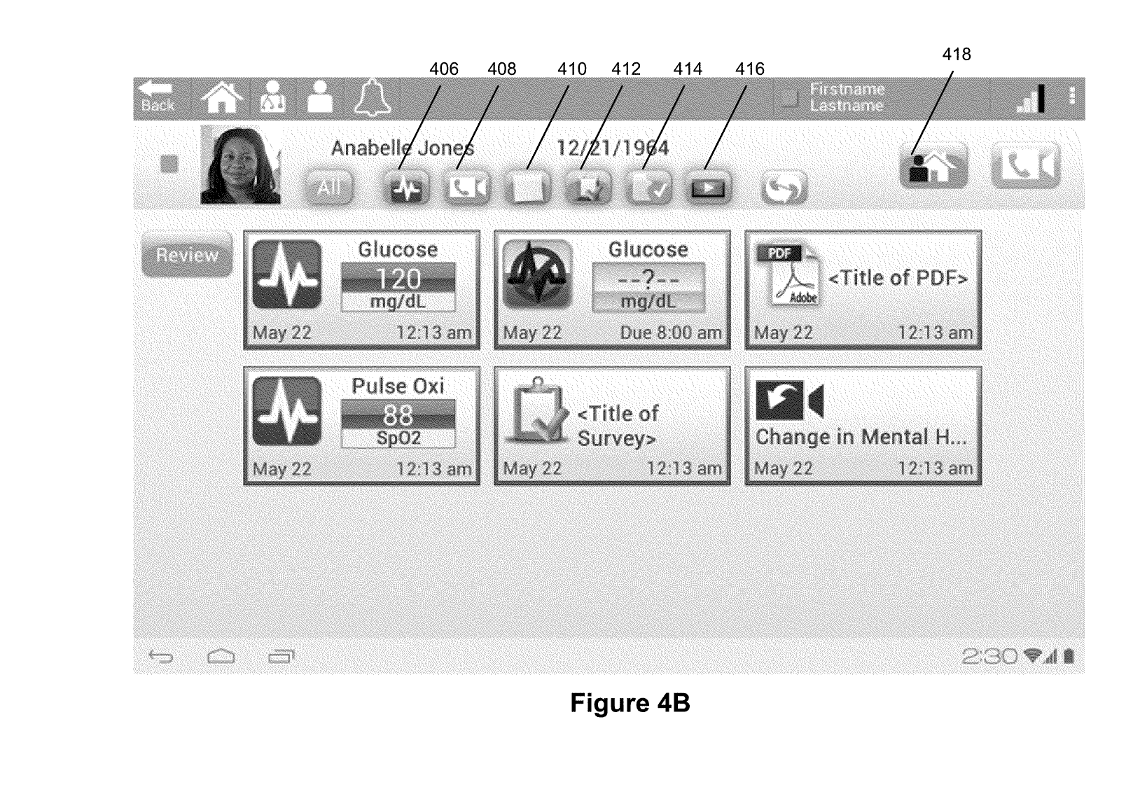

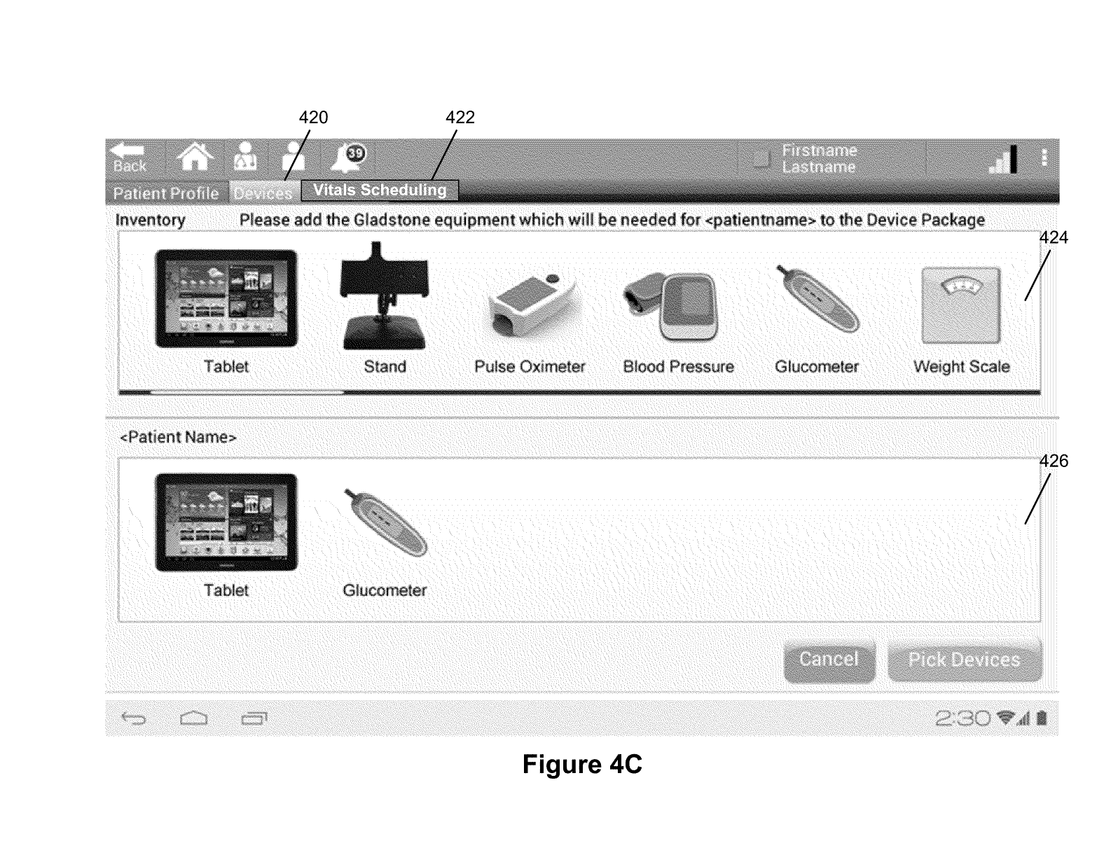

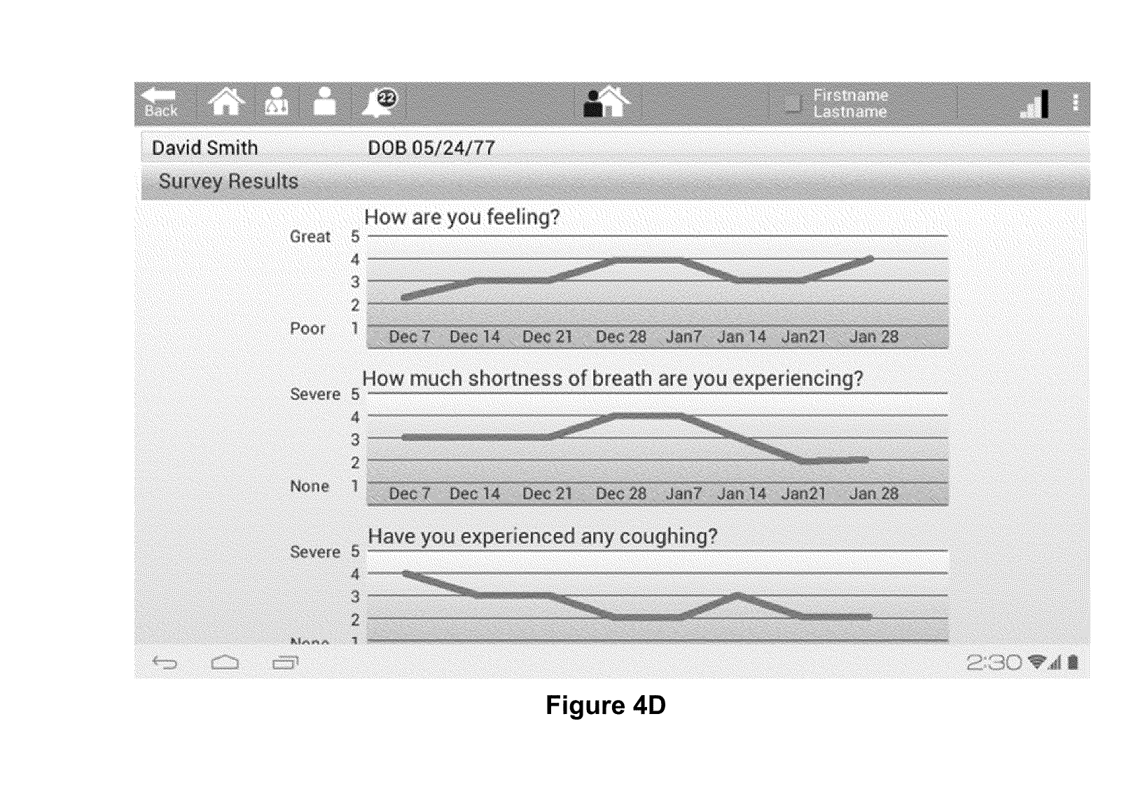

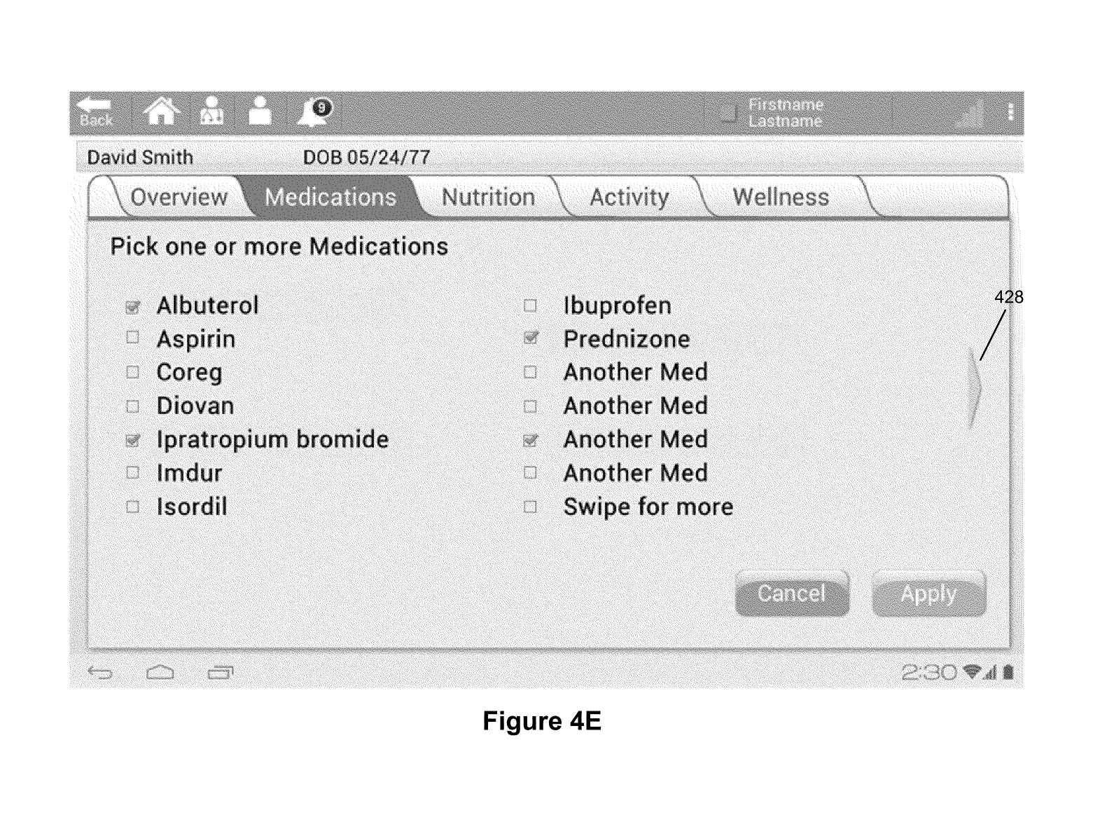

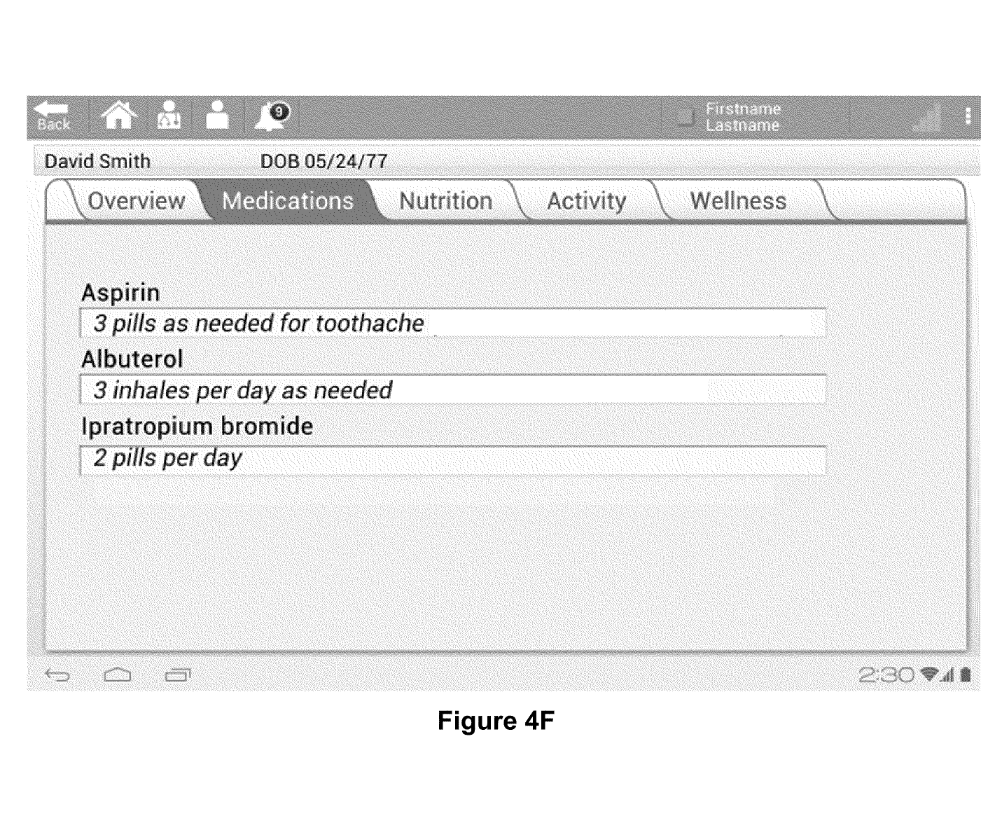

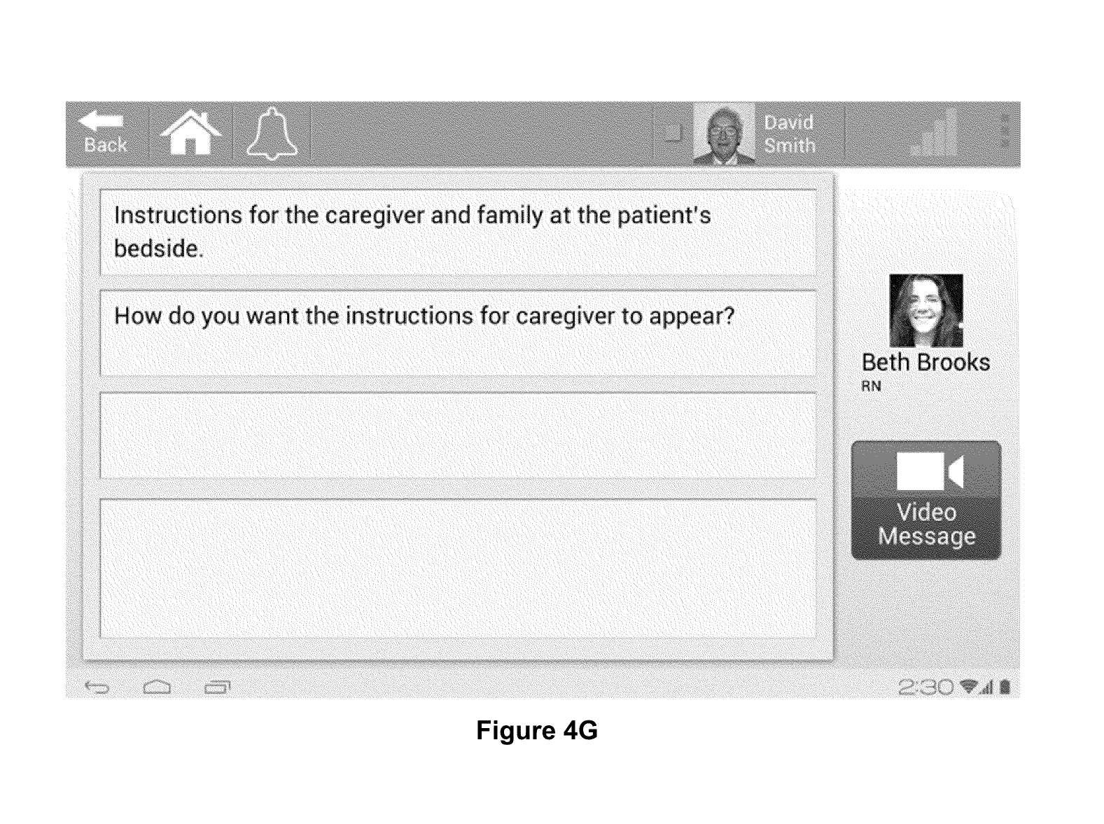

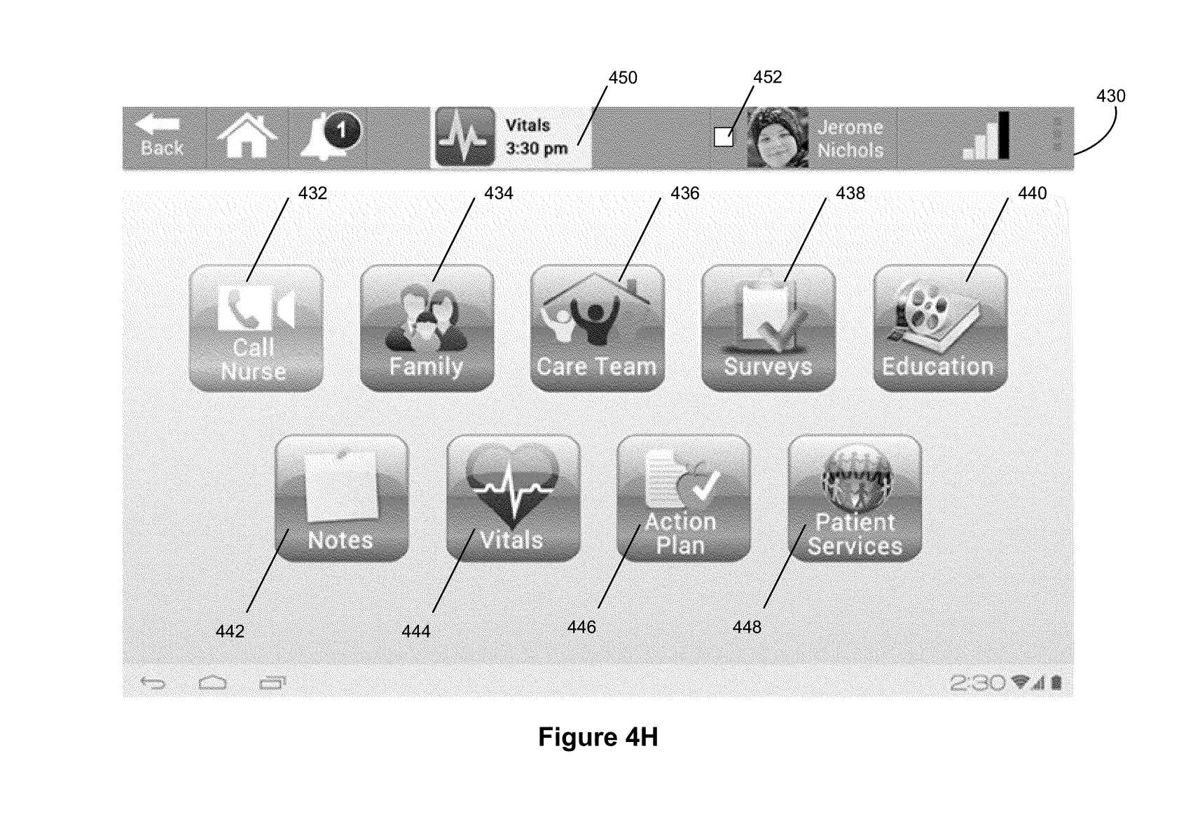

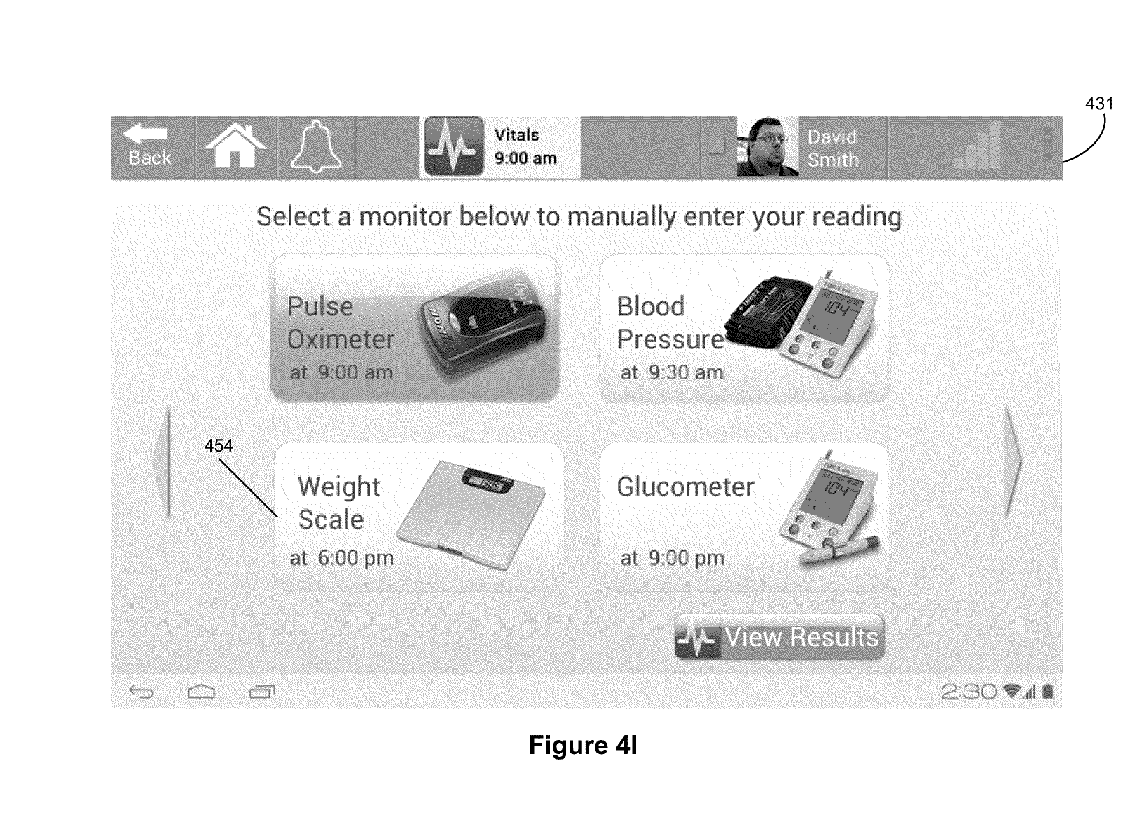

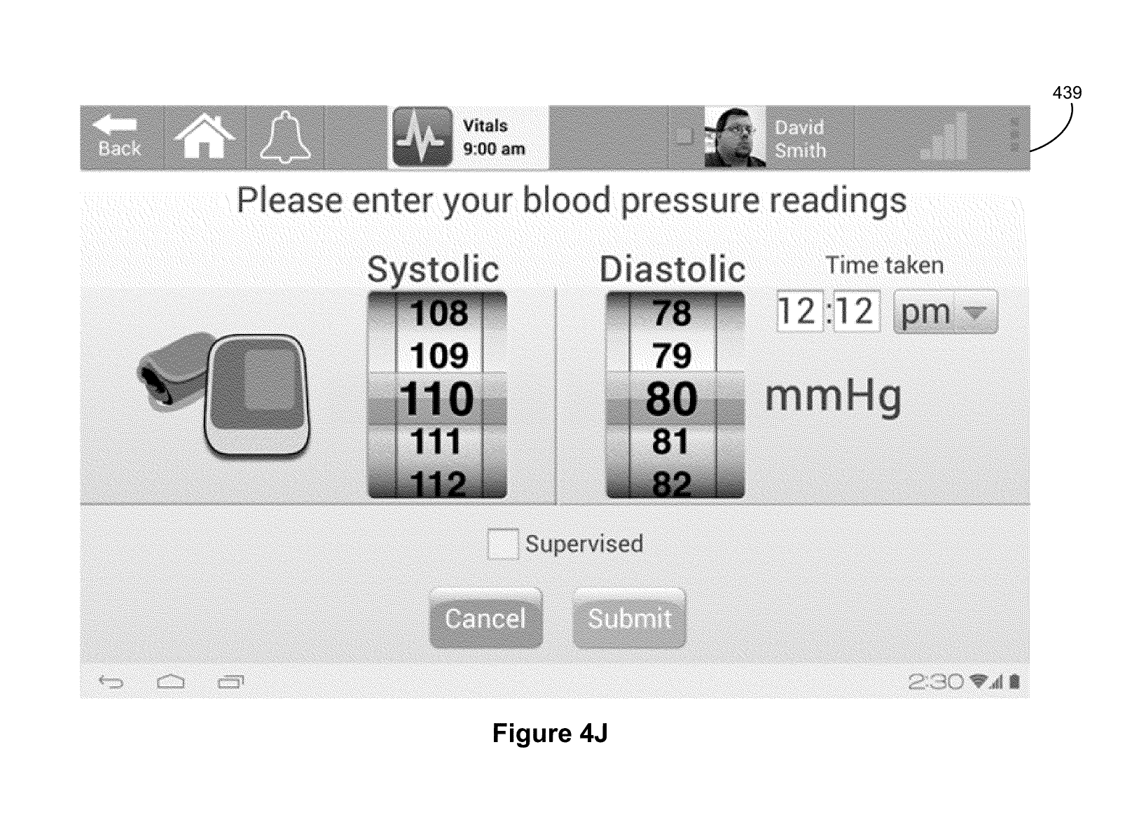

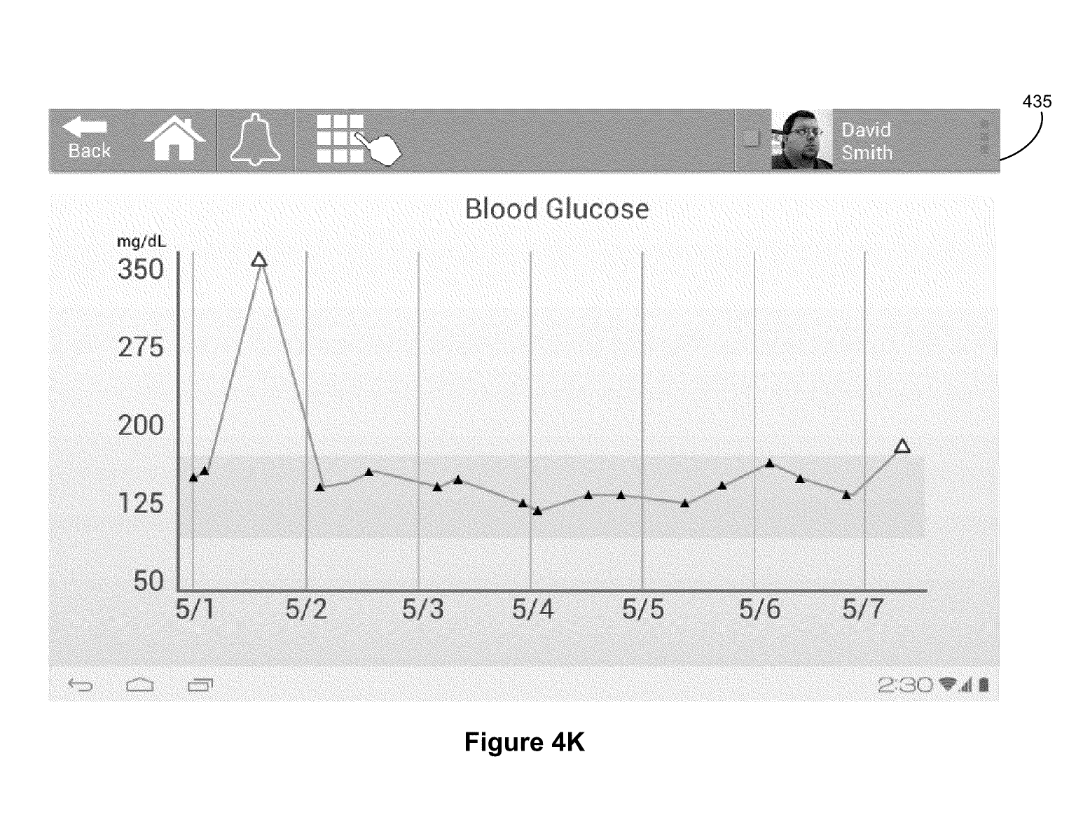

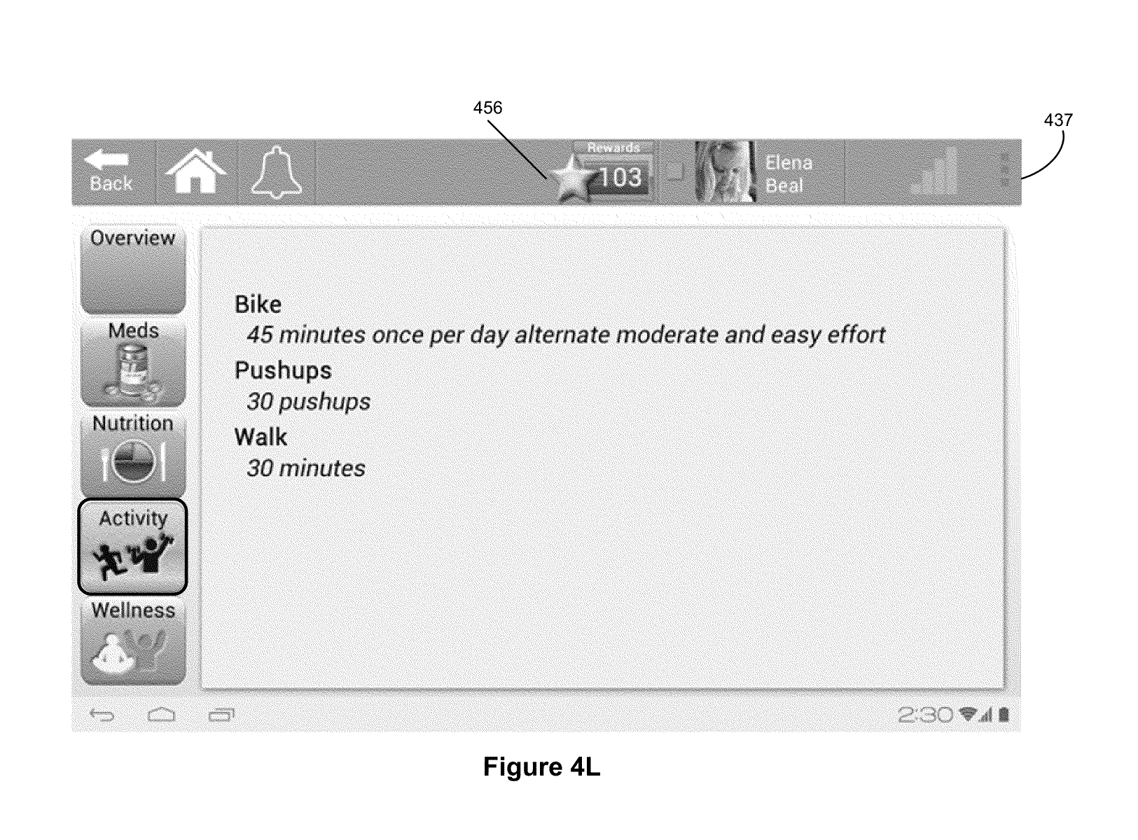

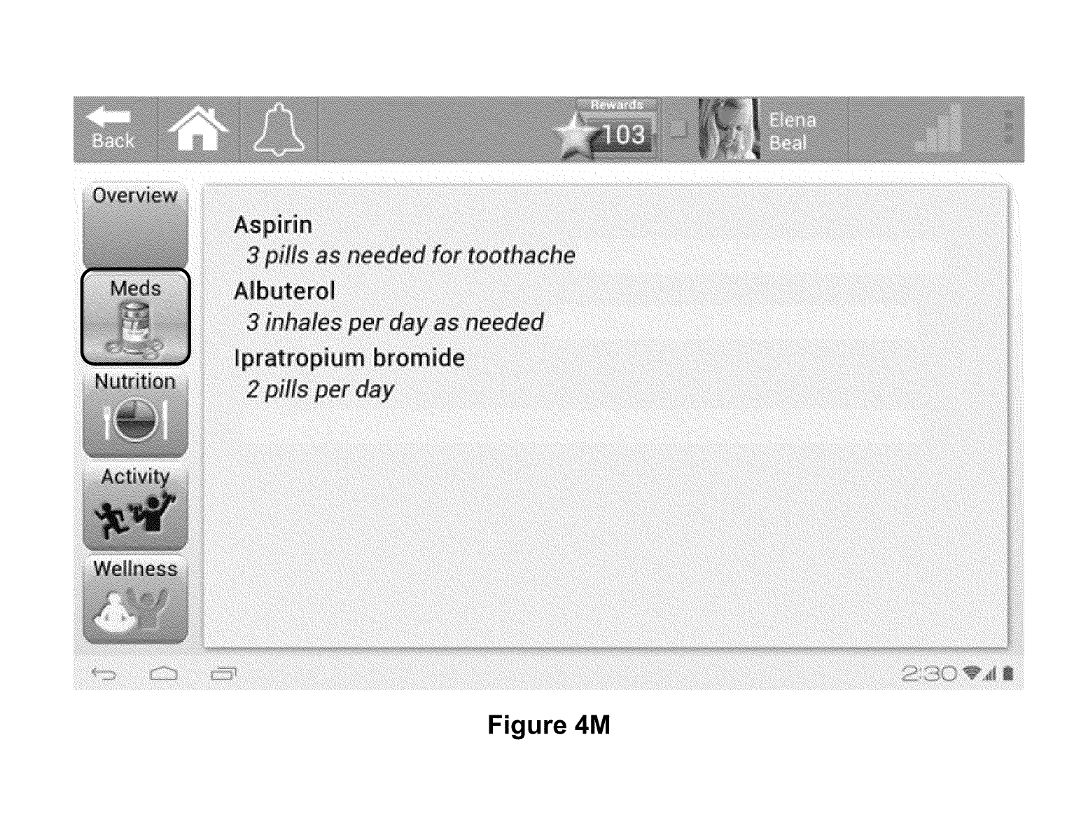

FIGS. 4A-4M illustrate exemplary user interfaces for a chronic disease management program, according to some embodiments.

FIG. 4A illustrates an exemplary user interface 400 that a care provider would see, while administering treatment to a patient through a chronic disease management platform, for example using a device 104 (FIG. 1). User interface 400 specifically shows a patient summary and assessment page that comprises a summary information bar 404. In some embodiments, information in summary information bar 404 includes the patient's name, patient's photo, patient's vital information (e.g., blood pressure readings), patient's statistics (e.g., weight), or other health-related information about the patient. In some embodiments, summary information bar 404 also comprises information about the patient's engagement with the chronic disease management platform (e.g., reward points or feedback from the patient's support team).

FIG. 4B illustrates an exemplary user interface for a care provider to see a patient's condition in a quick glance. This user interface allows a care provider to easily access several resources or perform certain actions regarding the patient, such as viewing a summary of the patient's interactions with his health team. Additionally, the user interface enables accessing vital information via affordance 406, viewing an audio and/or video call history log of communications with the patient via affordance 408, viewing sticky notes sent by the patient via affordance 410, viewing a survey that has been completed by the patient via affordance 412, accessing/modifying the patient's care plan via affordance 414, and viewing or modifying educational information/curriculum materials assigned to the patient via affordance 416 and switching to the patient's view of the chronic disease management platform via affordance 418.

FIG. 4C illustrates another exemplary user interface for a care provider. This user interface allows a care provider to select devices required to treat a particular patient in accordance with the chronic disease management plan. Tab 420 is an affordance to allow the care provider to access this user interface, and select any devices from device list 424 to be used by the patient (and displayed in list 426). Tab 422 provides a user interface to the care provider to set up and schedule one or more selected devices in list 426, for the patient.

FIG. 4D illustrates another exemplary user interface for a care provider. This interface displays charted results of survey questions defined by the care provider. For example, the care provider acquires a quick visual assessment of the patient's well-being over time, by observing a graphical representation of the patient's ranking of various health-related factors. In some embodiments, the care provider can change the scale of the graphical representations, or the time period over which the results are displayed.

FIG. 4E illustrates another exemplary user interface for a care provider. This interface displays the results of selecting one aspect (e.g., Medications), of the patient's chronic disease management plan, in order to view details about that aspect. For example, the Medications tab allows the care provider to see which medications are already prescribed for the patient, and allows the provider to change the prescribed or recommended medications. Affordances, such as affordance 428, allow the care provider to navigate among pages of medications. FIG. 4F illustrates a related user interface to allow the care provider to enter instructions for administration of the medications, such as dosages, frequency of administration or other quantitative or qualitative information regarding administration of the medication. FIG. 4G illustrates a simpler user interface within the patient's chronic disease management plan, where the care provider can write notes for other members of the patient's support staff (e.g., family members, nurses or social workers).

FIG. 4H illustrates a home screen for an exemplary user interface 430 for a patient using the chronic disease management platform, using for example client device 110 of FIG. 1. In user interface 430, the patient has quick access to various aspects of the chronic disease management platform, such as placing an audio or video call to a nurse or another medical practitioner via affordance 432, communicating through an audio or video call to family via affordance 434, viewing profiles of, or interacting with the patient's care team via affordance 436, taking a survey (e.g., administered by the patient's care provider) or viewing old survey results via affordance 438, accessing educational material (e.g., regarding the patient's chronic disease) via affordance 440, writing or reading notes via affordance 442, viewing or updating vital information (e.g., blood pressure, blood glucose readings) via affordance 444, accessing the patient's chronic disease management plan via affordance 446 and accessing patient services such as calling medical transportation or medical equipment vendors via affordance 448. User interface 430 for the patient also provides a dashboard or tool bar at the top of the home screen to provide the patient with convenient access to one or more features of the chronic disease management platform. One such feature is illustrated by panel 450 that alerts the patient to when he last provided vital information, such as a blood pressure reading, or indicates when he has to enter his next reading. Status icon 452 indicates the patient's availability for an audio or video call from his care provider, another medical practitioner, or a member of his support team (e.g., family, friends, social worker). In some embodiments, the patient manually sets his availability for an audio or video call, and in some embodiments his availability is automatically assessed by the chronic disease management platform (e.g., set to available if the patient is logged into the platform).

FIG. 4I illustrates an exemplary user interface 431 for a patient to manually enter his vital information, depending on the device used. Panel 454 provides an affordance for the patient to use for entry of his weight. In some embodiments, panel 454 also provides additional information, such as the last time a reading was entered for that particular device, the next time a reading is due, whether the care provider has requested a reading, how frequently a reading is requested for that device or other qualitative or quantitative information regarding vital information entered through that device. FIG. 4J illustrates an exemplary user interface 433 for manually entering blood pressure readings, and the time that the readings are taken. FIG. 4K illustrates an exemplary user interface 435 to view the patient's previously entered vital information readings, over time.

FIG. 4L illustrates an exemplary user interface 437 for a patient to view his personalized chronic disease management plan under the chronic disease management platform. Here, the activity tab is selected, to display the prescribed activity the patient is suggested to undertake. In some embodiments, the user-specific chronic disease management plan is automatically generated by the chronic disease management platform, and in some embodiments the user-specific chronic disease management plan is manually entered by the patient's care provider, another medical practitioner or a member of the patient's support team. FIG. 4L also illustrates panel 456 that indicates a value of reward points that the patient has accumulated. In some embodiments, some or all actions that the patient performs based on his user-specific chronic disease management plan are rewarded by giving the patient reward points. In some embodiments, the points accumulated can be redeemed for various tangible rewards such as gas station gift cards, grocery store gift cards, entertainment services gift cards and video game downloads. In some embodiments, the reward points and the redeemable value of the points is set by the health care team, care provider or health insurance payer to incentivize positive health related behavior. In some embodiments, factors associated with the reward points are determined in accordance with the patient's socio-economic vector values (e.g., see discussion above regarding FIGS. 3A and 3B).

FIG. 4M illustrates another exemplary user interface 439 for a patient to view his personalized chronic disease management plan under the chronic disease management platform. Here, the medication tab is selected, to display the prescribed medication the patient is required to take, per his care provider's or another medical practitioner's advice.

FIGS. 5A-5B are flow charts of a method 500 for chronic disease management, according to some embodiments.

The method includes obtaining (502) one or more user-specific socio-cognitive vectors (or scores for the vectors) corresponding to a first user. In some embodiments, the one or more socio-cognitive vectors include (504) at least one of the following: learning style, self-motivation, current knowledge of the chronic disease, current knowledge of treatment of the chronic disease, self-efficacy, communication style, psychological state, age, economic state, language, support system, motivational anchors, social context comfort with technology, organization skills and education level. In some embodiments, obtaining (506) one or more user-specific socio-cognitive vectors (or vector scores) corresponding to a first user is performed by one or more of the following techniques: electronic communication, in-person communication, telephonic communication, online questionnaire and communication through an authorized representative.

The method includes creating (508) a user-specific engagement model in accordance with the one or more obtained socio-cognitive vectors (or vector scores). The method further includes generating (510) a user-specific chronic disease management plan for the first user, in accordance with the user-specific engagement model.

In some embodiments, the method further includes obtaining (512) feedback from the first user regarding the user-specific socio-cognitive vectors. For example, the user takes a survey or provides feedback directly to his care provider or an administrator of the chronic disease management plan regarding his preferences. In some embodiments, the method further includes revising (514) the chronic disease management plan, in accordance with the user-specific socio-cognitive vectors in the obtained feedback.

In some embodiments, the method further includes obtaining (516) feedback from an entity other than the first user regarding the user-specific socio-cognitive vectors. In some embodiments, the method further includes revising (518) the chronic disease management plan, in accordance with the user-specific socio-cognitive vectors in the obtained feedback.

In some embodiments, the method further includes monitoring (520) performance of the first user's engagement with the chronic disease management plan. In some embodiments, monitoring performance of the first user's engagement with the chronic disease management plan comprises obtaining (522) one or more biometric readings for the first user over a predetermined period of time. In some embodiments, the method further includes revising (524) the chronic disease management plan, in accordance with the monitored performance of the first user's engagement.

The foregoing description, for purposes of explanation, used specific nomenclature to provide a thorough understanding of the invention. Nevertheless, the foregoing descriptions of the preferred embodiments of the present invention are presented for purposes of illustration and description and are not intended to be exhaustive or to limit the invention to the precise forms disclosed; obvious modifications and variations are possible in view of the above teachings. Modern computer equipment and software facilitate numerous configurations of the various aspects of the present invention without deviating from the scope of the invention. For example, it does not matter whether the renewal server is part of or separate from the dispenser server. Furthermore, much of the data transfer can take place in either direction, while still accomplishing the desired end, e.g., transfer of information to a specific place. In addition, the various databases may be replaced by a central database. The renewal server, dispenser and prescriber then access the centralized database to obtain data. Access to the centralized database preferably occurs in real time via “always-on” connections. A skilled artisan will readily recognize that these and many other insubstantial variations of the preferred embodiments described above may be implemented without deviating from the scope of the present invention, as defined below.

What is claimed is:

1. A method for chronic disease management, comprising:
at a server having one or more processors and memory storing one or more programs for execution by the one or more processors:
obtaining one or more user-specific socio-cognitive vectors corresponding to a first user;
creating a user-specific engagement model in accordance with the one or more obtained socio-cognitive vectors; and
generating a user-specific chronic disease management plan for the first user, in accordance with the user-specific engagement model.

2. The method of claim 1, further comprising:
obtaining feedback from the first user regarding the one or more user-specific socio-cognitive vectors; and
revising the chronic disease management plan, in accordance with the user-specific socio-cognitive vectors and the obtained feedback.

3. The method of claim 1, further comprising:
obtaining feedback from an entity other than the first user regarding the user-specific socio-cognitive vectors; and
revising the chronic disease management plan, in accordance with the user-specific socio-cognitive vectors and the obtained feedback.

4. The method of claim 1, further comprising:
monitoring performance of the first user's engagement with the chronic disease management plan; and
revising the chronic disease management plan, in accordance with the monitored performance of the first user's engagement.

5. The method of claim 4, wherein monitoring performance of the first user's engagement with the chronic disease management plan comprises obtaining one or more biometric readings for the first user over a predetermined period of time.

6. The method of claim 1, wherein the one or more socio-cognitive vectors include at least one of the following:
learning style, self-motivation, current knowledge of the chronic disease, current knowledge of treatment of the chronic disease, self-efficacy, communication style, psychological state, age, economic state, language, support system, motivational anchors, social context comfort with technology, organization skills and education level.

7. The method of claim 1, wherein the obtaining one or more user-specific socio-cognitive vectors corresponding to the first user is performed by one or more of the following techniques:
electronic communication, in-person communication, telephonic communication, online questionnaire and communication through an authorized representative.

8. A computing system, comprising:
one or more processors;
memory; and
one or more programs, wherein the one or more programs are stored in the memory and are configured to be executed by the one or more processors, the one or more programs including instructions for:
obtaining one or more user-specific socio-cognitive vectors corresponding to a first user;
creating a user-specific engagement model in accordance with the one or more obtained socio-cognitive vectors; and
generating a user-specific chronic disease management plan for the first user, in accordance with the user-specific engagement model.

9. The system of claim 8, wherein the one or more programs further include instructions for:
obtaining feedback from the first user regarding the one or more user-specific socio-cognitive vectors; and
revising the chronic disease management plan, in accordance with the user-specific socio-cognitive vectors and the obtained feedback.

10. The system of claim 8, wherein the one or more programs further include instructions for:
obtaining feedback from an entity other than the first user regarding the user-specific socio-cognitive vectors; and
revising the chronic disease management plan, in accordance with the user-specific socio-cognitive vectors in the obtained feedback.

11. The system of claim 8, wherein the one or more programs further include instructions for:
monitoring performance of the first user's engagement with the chronic disease management plan; and
revising the chronic disease management plan, in accordance with the monitored performance of the first user's engagement.

12. The system of claim 11, wherein monitoring performance of the first user's engagement with the chronic disease management plan comprises obtaining one or more biometric readings for the first user over a predetermined period of time.

13. The system of claim 8, wherein the one or more socio-cognitive vectors include at least one of the following:
learning style, self-motivation, current knowledge of the chronic disease, current knowledge of treatment of the chronic disease, self-efficacy, communication style, psychological state, age, economic state, language, support system, motivational anchors, social context comfort with technology, organization skills and education level.

14. The system of claim 8, wherein the obtaining one or more user-specific socio-cognitive vectors corresponding to the first user is performed by one or more of the following techniques:
electronic communication, in-person communication, telephonic communication, online questionnaire and communication through an authorized representative.

15. A non-transitory computer readable storage medium storing one or more programs, the one or more programs comprising instructions, which when executed by a computing system with one or more processors, cause the computing system to execute a method of:
obtaining one or more user-specific socio-cognitive vectors corresponding to a first user;
creating a user-specific engagement model in accordance with the one or more obtained socio-cognitive vectors; and
generating a user-specific chronic disease management plan for the first user, in accordance with the user-specific engagement model.

16. The non-transitory computer readable storage medium of claim 15, further comprising instructions that cause the computing system to execute a method of:
obtaining feedback from the first user regarding the one or more user-specific socio-cognitive vectors; and
revising the chronic disease management plan, in accordance with the user-specific socio-cognitive vectors and the obtained feedback.

17. The non-transitory computer readable storage medium of claim 15, further comprising instructions that cause the computing system to execute a method of:
obtaining feedback from an entity other than the first user regarding the user-specific socio-cognitive vectors; and
revising the chronic disease management plan, in accordance with the user-specific socio-cognitive vectors and the obtained feedback.

18. The non-transitory computer readable storage medium of claim 15, further comprising instructions that cause the computing system to execute a method of:
monitoring performance of the first user's engagement with the chronic disease management plan; and
revising the chronic disease management plan, in accordance with the monitored performance of the first user's engagement.

19. The non-transitory computer readable storage medium of claim 18, wherein monitoring performance of the first user's engagement with the chronic disease management plan comprises obtaining one or more biometric readings for the first user over a predetermined period of time.

20. The non-transitory computer readable storage medium of claim 15, wherein the one or more socio-cognitive vectors include at least one of the following:
learning style, self-motivation, current knowledge of the chronic disease, current knowledge of treatment of the chronic disease, self-efficacy, communication style, psychological state, age, economic state, language, support system, motivational anchors, social context comfort with technology, organization skills and education level.
